(19) United States
(12) Patent Application Publication
(10) Pub. No.: US 2008/0161093 A1
(43) Pub. Date: Jul. 3, 2008

(54) SLOT MACHINE AND PLAYING METHOD OF SLOT MACHINE

(75) Inventor: Kazuo OKADA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 11/954,967

(22) Filed: Dec. 12, 2007

(30) Foreign Application Priority Data
Dec. 14, 2006 (JP) 2006-336974

(51) Int. Cl. A63F 13/00

(52) U.S. Cl. 463/20

(57) ABSTRACT

A slot machine comprises a display, an input device and a CPU. The display is provided with slot game areas each in which a slot game is executed to rearrange symbols arranged thereon. The input device reads the number of credits bet by a player. The CPU activates one or more slot game areas according to the number of credits read by the input device, executes one or more slot games on one or more activated slot game areas, and changes an amount of payout, which is determined based on symbols rearranged on one or more activated slot game areas, according to a result of slot game executed on a specified slot game area.

### CROSS REFERENCE TO RELATED APPLICATION

This application claims benefit of priority under 35 U.S.C. §119 to Japanese Patent Application No. 2006-336974, filed on Dec. 14, 2006, the entire contents of which are incorporated by reference herein.

### BACKGROUND OF THE INVENTION

1. Field of the Invention

The present invention relates to a slot machine which allows a player to play a game by using one or more game media such as medals and a playing method of the slot machine.

2. Description of the Related Art

When a player inserts one or more medals into an input device and operates a start button, a conventional slot machine rotates plural reels (e.g. three reels) each on which plural symbols are provided. Then, the conventional slot machine stops the rotation of plural reels when a predetermined time has elapsed. In a case where a symbol combination in which a payout is provided is statically displayed on a payline or scatter symbols are statically displayed, the conventional slot machine provides a payout according to the number of medals inserted into the input device.

Another conventional slot machine is disclosed in U.S. Pat. No. 6,855,052. In a case where a symbol combination displayed at a time when the rotation of plural reels is stopped is one of predetermined symbol combinations, the conventional slot machine sequentially rotates plural wheels which are mounted above the plural reels, and then stops the rotation of plural wheels. When a stop state of the plural wheels is a predetermined stop state, the conventional slot machine payouts a large number of medals.

The conventional slot machine however executes only one-time slot game with respect to one-time insertion of one or more medals. Therefore, it is desired to provide a slot machine that executes plural-times slot games with respect to one-time insertion of one or more medals.

### SUMMARY OF THE INVENTION

It is an object of the present invention to provide a slot machine capable of increasing entertainment factors and a playing method of the slot machine.

In order to achieve the object, the present invention provides a slot machine comprising: a display that is provided with slot game areas each in which a slot game is executed to rearrange symbols arranged thereon; an input device that reads the number of credits bet by a player; and a controller that activates one or more slot game areas according to the number of credits read by the input device, executes one or more slot games on one or more activated slot game areas, and changes an amount of payout, which is determined based on symbols rearranged on one or more activated slot game areas, according to a result of slot game executed on a specified slot game area.

In order to achieve the object, the present invention provides a playing method of a slot machine comprising: reading the number of credits bet by a player; activating one or more slot game areas according to the number of read credits; executing one or more slot games on one or more activated slot game areas; determining an amount of payout that is determined based on symbols rearranged on one or more activated slot game areas; and changing the amount of payout according to a result of slot game executed on a specified slot game area.

According to the present invention, the slot machine and the playing method of the slot machine allow a player to execute plural-times slot games with respect to one-time insertion of one or more medals or one-time bet of one or more credits, and change the amount of payout according to the result of slot game executed on the specified slot game area. Therefore, the slot machine and the playing method of the slot machine increase player's expectations and entertainment factors.

### BRIEF DESCRIPTION OF THE DRAWINGS

FIG.1 is an explanatory view of eleven slot game areas displayed on a display of a slot machine according to an exemplary embodiment of the present invention.

FIG.2 is a perspective view of the slot machine according to the exemplary embodiment of the present invention.

FIG.3 is a block diagram of a control circuit of the slot machine according to the exemplary embodiment of the present invention.

FIG.4 is a flowchart of a process procedure of the slot machine according to the exemplary embodiment of the present invention.

FIG.5 is a flowchart of a process procedure of the slot machine according to the exemplary embodiment of the present invention.

FIG.6 is a flowchart of a process procedure of the slot machine according to the exemplary embodiment of the present invention.

FIG.7 is a flowchart of a process procedure of the slot machine according to the exemplary embodiment of the present invention.

FIG.8 is a flowchart of a process procedure of the slot machine according to the exemplary embodiment of the present invention.

FIG.9 is a flowchart of a process procedure of the slot machine according to the exemplary embodiment of the present invention.

FIG.10 is a perspective view of the display of the slot machine, through looking from a rear side of the display, according to the exemplary embodiment of the present invention.

FIG.11 is an exploded perspective view of the display of the slot machine according to the exemplary embodiment of the present invention.

FIG.12 is an explanatory view of a specified slot game area of the slot machine according to the exemplary embodiment of the present invention.

FIG. 13 is an explanatory view of each of slot game areas other than the specified slot game area of the slot machine according to the exemplary embodiment of the present invention.

FIG.14 is an explanatory view of paylines in each of the slot game areas other than the specified slot game area of the slot machine according to the exemplary embodiment of the present invention.

FIG.15 is an explanatory view of a relation between a winning combination and an amount of payout and a relation between a winning combination and a multiplying factor in the slot machine according to the exemplary embodiment of the present invention.

FIG. 16 is an explanatory view of eleven slot game areas displayed on the display of the slot machine according to the exemplary embodiment of the present invention.

FIG.17 is an explanatory view of eleven slot game areas displayed on the display of the slot machine according to the exemplary embodiment of the present invention.

FIG. 18 is an explanatory view of a relation between the number of bet credits and a slot game area to be bet in the slot machine according to the exemplary embodiment of the present invention.

FIG. 19 is an explanatory view of a relation between the number of bet credits and a slot game area to be bet in the slot machine according to the exemplary embodiment of the present invention.

### DESCRIPTION OF THE PREFERRED EMBODIMENTS

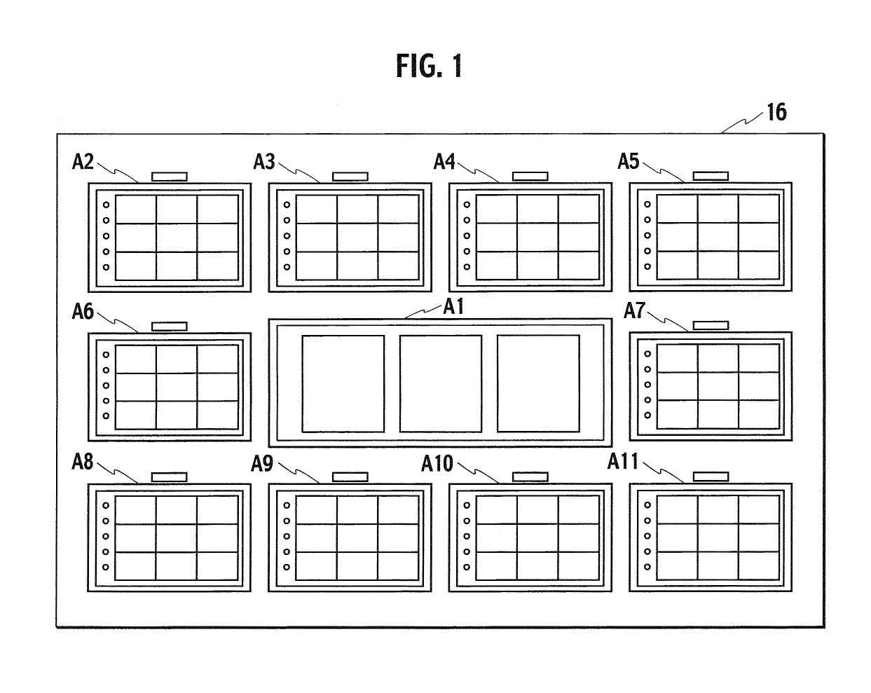

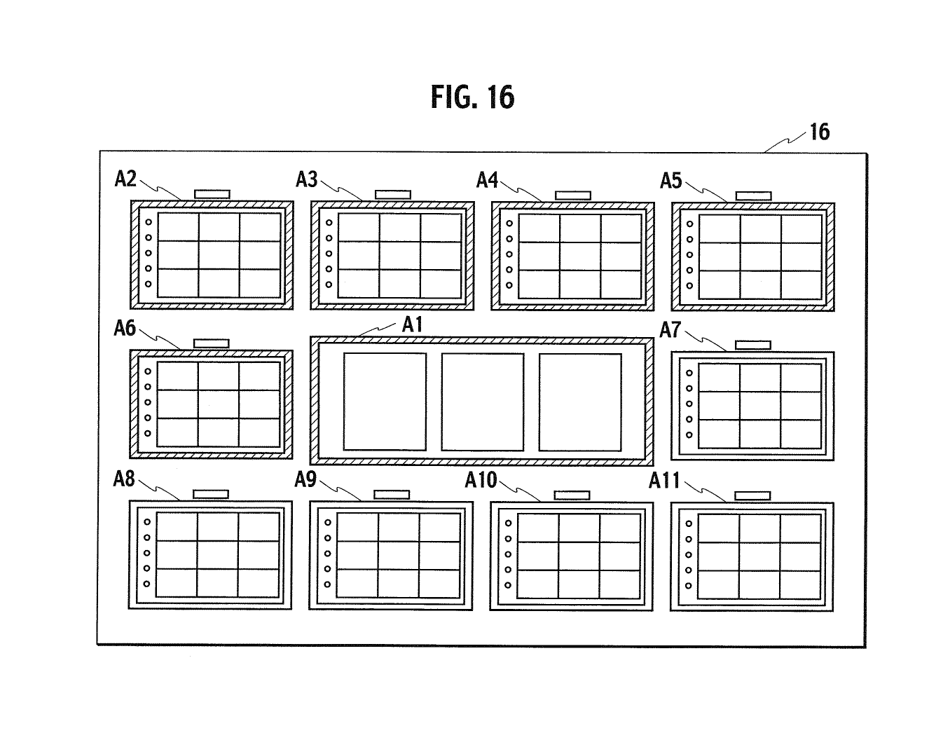

With reference to FIGS. 1 to 19, an exemplary embodiment of the present invention will be described below.

A display 16 of a slot machine 10 shown in FIG.1 includes a liquid crystal display and rotation reels 3A, 3B, 3C provided on a back surface of the liquid crystal display (see FIG.10). Eleven slot game areas A1 to A11 are provided on the display 16. The slot machine 10 causes a player to play one or more slot games on one or more bet slot game areas.

We will describe a slot game area Al as a specified slot game area A1 below, as needed. The rotation reels 3A, 3B, 3C rotate to variably display (scroll) symbols on the specified slot game area A1. A display region in the matrix state which includes one row and three columns is set on the specified slot game area A1. When a player inserts one or more medals into the slot machine 10 or presses a BET switch 25, one or more credits are bet on the specified slot game area A1. Then, when the player presses a start switch 27, the slot machine 10 variably displays (scrolls) symbols arranged on the display region and then statically displays (rearranges) symbols on the display region.

Video reels rotate to variably display (scroll) symbols on each of slot game areas A2 to A11 other than the specified slot game area A1. A display region in the matrix state which includes three rows and three columns is set on each of the slot game areas A2 to A11. When a player inserts one or more medals into the slot machine 10 or presses the BET switch 25, one or more credits are sequentially bet on the slot game areas A2 to A11 after bet on the specified slot game area A1. Then, when the player presses the start switch 27, the slot machine 10 variably displays (scrolls) symbols arranged on each display region and then statically displays (rearranges) symbols on each display region.

In slot games to be played on the slot game areas Al to A11, a player can bet on one or more slot game areas one or more credits corresponding to one, two, or three medals. When a player inserts one or more medals into a medal insertion slot (input device) 21 or presses the BET switch 25, one or more credits are sequentially bet on the slot game areas A1 to A11. For example, when the player inserts one medal into the medal insertion slot 21, one or more credits corresponding to one medal are firstly bet on the slot game area A1. When the player inserts two medals into the medal insertion slot 21, one or more credits corresponding to two medals are firstly bet on the slot game area A1. As will be described later, one or more credits are preferentially bet on one or more slot game areas each on which a bonus game is being played.

When the slot games are played on the slot game areas A1 to A11 and symbols constituting a winning combination are statically displayed on an activated payline of each bet slot game area, the slot machine 10 pays out one or more medals associated to the winning combination or adds one or more credits associated to the winning combination to one or more credits stored in the slot machine 10. In this configuration, the slot machine 10 allows a player to simultaneously play a plurality of slot games.

In slot games to be played on the slot game areas A2 to A11, the number of paylines of each bet slot game area to be activated increases as the number of credits bet on each slot game area increases. For example, when a player bets one or more credits corresponding to one medal on a slot game area, the slot machine 10 activates one payline on the slot game area. When a player bets one or more credits corresponding to two medals on the slot game area, the slot machine 10 activates three paylines on the slot game area.

On the other hand, in a slot game to be played on the specified slot game area A1, the amount of payout increases as the number of credits bet on the specified slot game area A1 increases. For example, when a player bets one or more credits corresponding to one medal on the specified slot game area A1, the slot machine 10 pays out the amount of payout corresponding to two medals under a condition where symbols constituting a winning combination are statically displayed on an activated payline of the specified slot game area A1. When a player bets one or more credits corresponding to three medals on the specified slot game area A1, the slot machine 10 pays out the amount of payout corresponding to six medals under a condition where symbols constituting a winning combination are statically displayed on the activated payline.

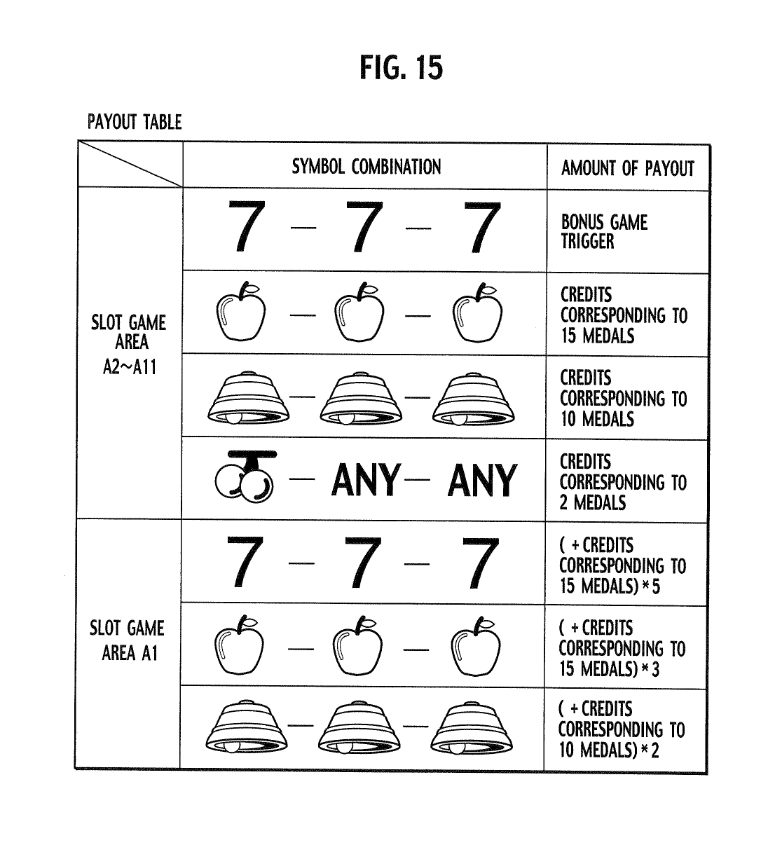

The slot machine 10 changes the total amount of payout which is determined based on symbols stopped on activated paylines of one or more bet slot game areas, according to a play result of the specified slot game area A1. For example, when the total amount of payout corresponds to fifty medals and three “BELL” symbols are stopped on the specified slot game area A1, the slot machine 10 changes the total amount of payout corresponding to fifty medals into new total amount of payout corresponding to one hundred medals (see FIG.15). That is, the slot machine 10 doubles the total amount of payout when three “BELL” symbols are stopped on the specified slot game area A1.

In the exemplary embodiment, the slot machine 10 allows a player to play a plurality of slot games on two or more bet slot game areas. This allows a player to play plural-times slot games with respect to one-time insertion of one or more medals. Also, the slot machine 10 changes the total amount of payout according to the result of a slot game played on the specified slot game area A1. This allows a player to have expectations for a change of the total amount of payout, which increases entertainment factors.

Although a player inserts one or more medals into the medal insertion slot 21 to bet one or more credits on one or more slot game areas, the slot machine 10 may receive one or more coins, one or more bills, or a ticket with a barcode other than one or more medals. Also, although the slot games are simultaneously played on the slot game areas A1 to A11, they may be independently played on the slot game areas A1 to A11. Further, in each slot game, although symbols are scrolled and then rearranged on each bet slot game area, they may be varied and then rearranged on each bet slot game area.

Although a player can bet on each slot game area one or more credits corresponding to one, two, or three medals, he/she may bet on each slot game one or more credits corresponding to four or more medals. Also, although the slot machine 10 doubles the total amount of payout when three “BELL” symbols are stopped on the specified slot game area A1, it may multiply the total amount of payout by an integer number other than two or a fractional number or may add/subtract an integer number to/from the total amount of payout.

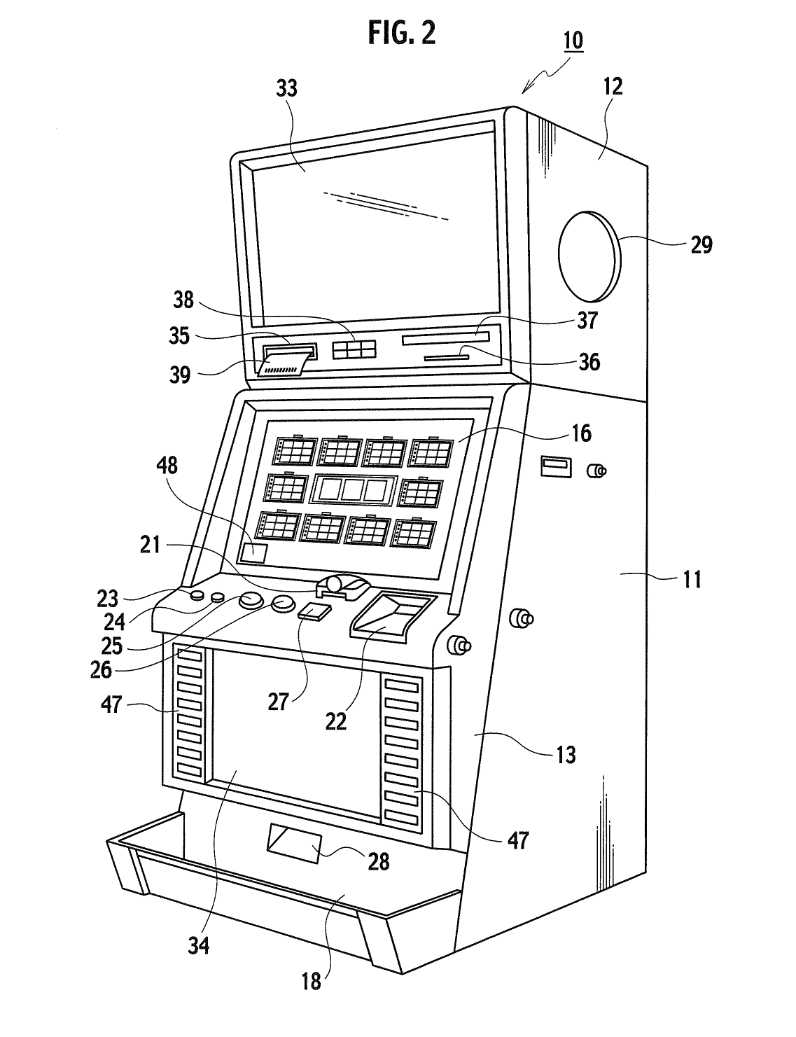

Next, with reference to FIG.2, a configuration of the slot machine 10 will be described below.

The slot machine 10 has the cabinet 11, a top box 12 mounted on a top surface of the cabinet 11 and an openable and closeable main door 13 mounted on a front surface of the cabinet 11. Also, the slot machine 10 has various members such as a controller 40 electrically-controlling operations of the slot machine 10 and a hopper 44 controlling an insertion, a collection, and a payout of one or more medals, in the cabinet 11.

The display 16 is mounted on an upper stage of the main door 13. Eleven slot game areas A1 to A11 are set on the display 16. The slot games are respectively played on the slot game areas A1 to A11. Although the display 16 has eleven slot game areas A1 to A11, it may have two or more slot game areas including at least one slot game area on which a slot game for changing the total amount of payout is played.

The display region in the matrix state which includes one row and three columns is set on the slot game area A1. The display region in the matrix state which includes three rows and three columns is set on each slot game area other than the slot game area A1. The slot machine 10 variably displays various symbols arranged on these display regions when starting slot games on the slot game areas A1 to A11. The slot machine 10 statically displays various symbols on these display regions after a predetermined time has elapsed. Then, the slot machine 10 provides a payout according to one or more symbol combinations statically displayed on one or more display regions of one or more bet slot game areas.

An amount-of-payout display region 48 on which the amount of payout is displayed is set on the bottom-left corner of the display 16.

The medal insertion slot 21 and a bill validator 22 are mounted on a lower side of the display 16. A player inserts one or more medals through the medal insertion slot 21 to play one or more slot games. The bill validator 22 checks whether or not an inserted bill is real and receives a real inserted bill. Various operation switches are mounted in the vicinity of the medal insertion slot 21 and the bill validator 22.

As the operation switches, a chashout switch 23, a MAX BET switch 24, a BET switch 25, a spin repeat bet switch 26 and a start switch 27 are mounted on the lower side of the display 16.

The BET switch 25 is a switch for inputting an instruction to determine the number of credits to be bet on one or more slot game areas. One or more credits corresponding to one medal are bet on a slot game area every time a player presses the BET switch 25. When one or more credits are bet on a slot game area, the slot games area is activated. If symbols constituting a winning combination are statically displayed on an activated payline of each bet slot game area, the slot machine 10 provides a payout.

The spin repeat bet switch 26 is a switch for inputting an instruction to bet on current slot games the number of credits which are equivalent to the number of credits bet on previous slot games and then start the current slot games.

The start switch 27 is a switch for inputting an instruction to start slot games on the slot game areas A1 to A11 after one or more credits are bet. A player presses the start switch 27 and then the slot machine 10 starts the slot games on the slot game areas A1 to A11, after one or more medals are inserted into the medal insertion slot 21 or one or more credits are bet by the BET switch 25.

The cashout switch 23 is a switch for inputting an instruction to payout one or more inserted medals. The one or more inserted medals are ejected from a medal payout slot 28 which opens on a front bottom of the main door 13. One or more ejected medals are stored on a medal tray 18.

The MAX BET switch 24 is a switch for inputting an instruction to bet the maximum number of credits (for example, the number of credits corresponding to thirty-three medals) which are allowed to be bet on the slot game areas A1 to All through one-time operation.

A foot display 34 is mounted on a front bottom side of the main door 13. The slot machine 10 displays various images regarding a slot game on the foot display 34. For example, the slot machine 10 displays characters on the foot display 34 as the images.

Lamps 47 are mounted on both sides of the foot display 34. The lamps 47 emit lights according to an emit pattern which is previously determined in the slot machine 10. The medal payout slot 28 is mounted on a lower side of the foot display 34.

An upper display 33 is mounted on a front side of the top box 12. The slot machine 10 displays the number of medals to be paid out according to each winning combination on the upper display 33 through a display panel of the upper display 33.

A speaker 29 is mounted on the top box 12. A ticket printer 35, a card reader 36, a data display 37 and a keypad 38 are mounted on a bottom side of the top box 12. The ticket printer 35 prints a barcode on a ticket, which includes coded data regarding the number of credits, date, an identification number of the slot machine 10 and the like, and outputs as a ticket attached with bar code 39.

With the ticket attached with bar code 39, a player can play a game on another slot machine or exchange to bills or the like at a certain portion of a game arcade (for example, a cashier in a casino).

The card reader 36 reads data from a smart card inserted therein or writes data into the smart card. The smart card is possessed by a player, on which data for identifying the player and regarding a history of games played by the player is stored.

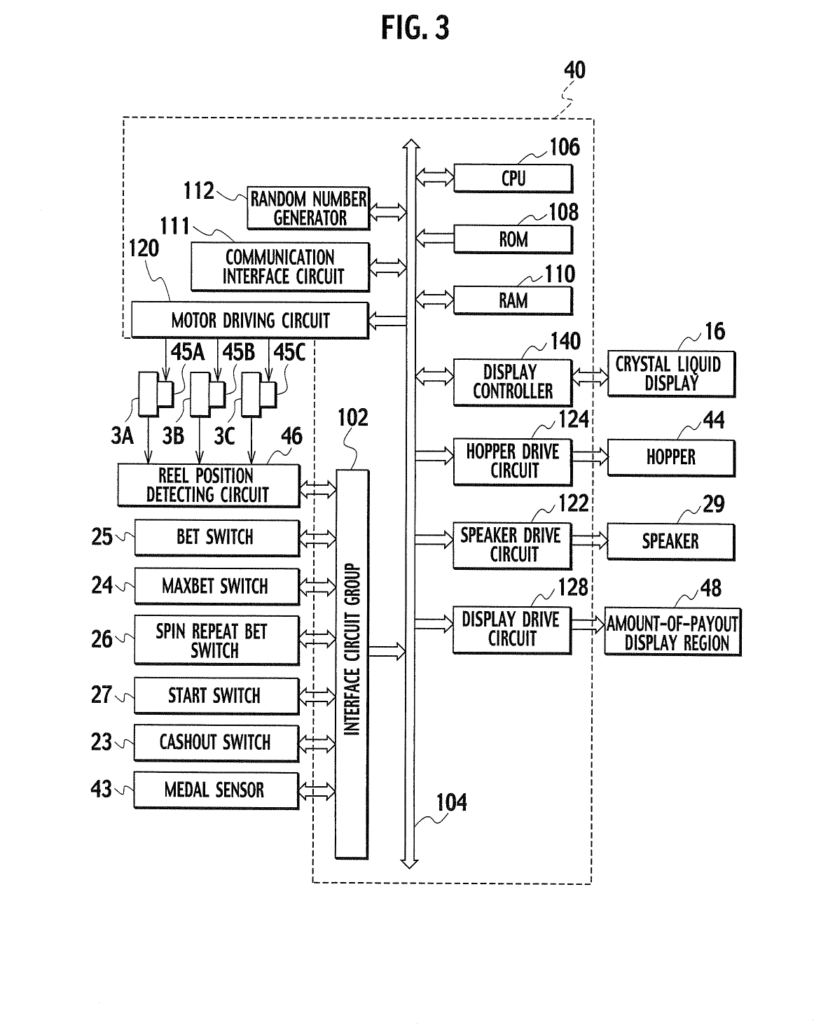

Next, with reference to FIG.3, an inner configuration of the slot machine 10 will be described below.

The slot machine 10 is provided with a controller 40. The controller 40 is a microcomputer and includes an interface circuit group 102, an input and output bus 104, a central processing unit (CPU) 106, a read only memory (ROM) 108, a random access memory (RAM) 110, a communication interface circuit 111, a random number generator 112, a motor drive circuit 120, a speaker drive circuit 122, a hopper drive circuit 124, a display drive circuit 128 and a display controller 140.

The interface circuit group 102 is connected to the input and output bus 104. A data signal or an address signal is input into or output from the CPU 106 through the input and output bus 104.

The start switch 27 is connected to the interface circuit group 102. A start signal output from the start switch 27 is converted into a certain signal in the interface circuit group 102 and then input into the CPU 106 through the input and output bus 104.

The cashout switch 23, the MAX BET switch 24, the BET switch 25 and the spin repeat bet switch 26 are connected to the interface circuit group 102. Each switch signal output from each switch is converted into a certain signal in the interface circuit group 102 and then input into the CPU 106 through the input and output bus 104.

A medal sensor 43 is connected to the interface circuit group 102. The medal sensor 43 is mounted on a medal insertion portion in the medal insertion slot 21 and detects a medal inserted into the medal insertion slot 21. A detect signal output from the medal sensor 43 is converted into a certain signal in the interface circuit group 102 and then input into the CPU 106 through the input and output bus 104.

The ROM 108 and the RAM 110 are connected to the input and output bus 104. Various system programs are permanently stored in the ROM 108. Various data are temporarily stored in the RAM 110. The communication interface circuit 111, the random number generator 112, the speaker drive circuit 122, the hopper drive circuit 124, the display drive circuit 128 and the display controller 140 are connected to the input and output bus 104.

The CPU 106 reads a game execution program to execute slot games when receiving the start signal from the start switch 27. The game execution program is a program for executing through the display controller 140 the slot games on the slot game areas A1 to A11 set on the display 16.

More specially, the CPU 106 variably displays and then statically displays symbols on the slot game areas A1 to All according to the game execution program. When a winning combination is arranged on a payline activated on each bet slot game area, the CPU 106 provides a payout according to the game execution program.

The communication interface circuit 111 is connected to a hall server and the like. A play history data for the slot machine 10 is input into the hall server through the communication interface circuit 111. The communication interface circuit 111 receives various data from the hall server.

The random number generator 112 generates a random number which is used to determine whether or not a winning combination is arranged on a payline activated on each bet slot game area in each slot game.

The display drive circuit 128 displays the amount of payout on the amount-of-payout display region 48 set on the bottom-left corner of the display 16.

The speaker drive circuit 122 outputs a sound data into the speaker 29. More specially, the CPU 106 reads the sound data stored in the ROM 108 and then inputs the sound data into the speaker drive circuit 122 through the input and output bus 104. Thereby, a certain effect sound is output from the speaker 29.

The hopper drive circuit 124 outputs a payout signal into the hopper 44 when a cashout signal is generated. More specially, when the cashout switch 23 inputs the cashout signal into the CPU 106, the CPU 106 outputs a drive signal into the hopper drive circuit 124 through the input and output bus 104. Thereby, the hopper 44 pays out one or more medals corresponding to one or more remaining credits which are stored in a certain memory region of the RAM 110 at the time.

The display controller 140 carries out a display control when the CPU 106 executes slot games on the slot game areas A2 to A11 set on the display 16. More specially, the CPU 106 generates an image display order signal according to a state of each slot game and a result of each slot game and then outputs the image display order signal into the display controller 140 through the input and output bus 104. When the display controller 140 receives the image display order signal from the CPU 106, it generates a drive signal for driving the display 16 on the basis of the image display order signal and then outputs the drive signal into the display 16. Thereby, a certain image is displayed on the display 16.

The motor drive circuit 120 drives stepping motors 45A, 45B, 45C. The motor drive circuit 120 generates a drive signal for driving the stepping motors 45A, 45B, 45C according to a signal from the CPU 106. Then, the motor drive circuit 120 outputs the drive signal into the stepping motors 45A, 45B, 45C. Thereby, the stepping motors 45A, 45B, 45C are driven. The stepping motors 45A, 45B, 45C are connected to the rotation reels 3A, 3B, 3C on which symbols are drawn. When the stepping motors 45A, 45B, 45C are driven, the rotation reels 3A, 3B, 3C are rotated to variably display symbols on the specified slot game area A1.

A reel position detection circuit 46 detects symbols, which have passed through a predetermined position thereof, to input a position detection signal into the CPU 106 through the interface circuit group 102 and the input and output bus 104.

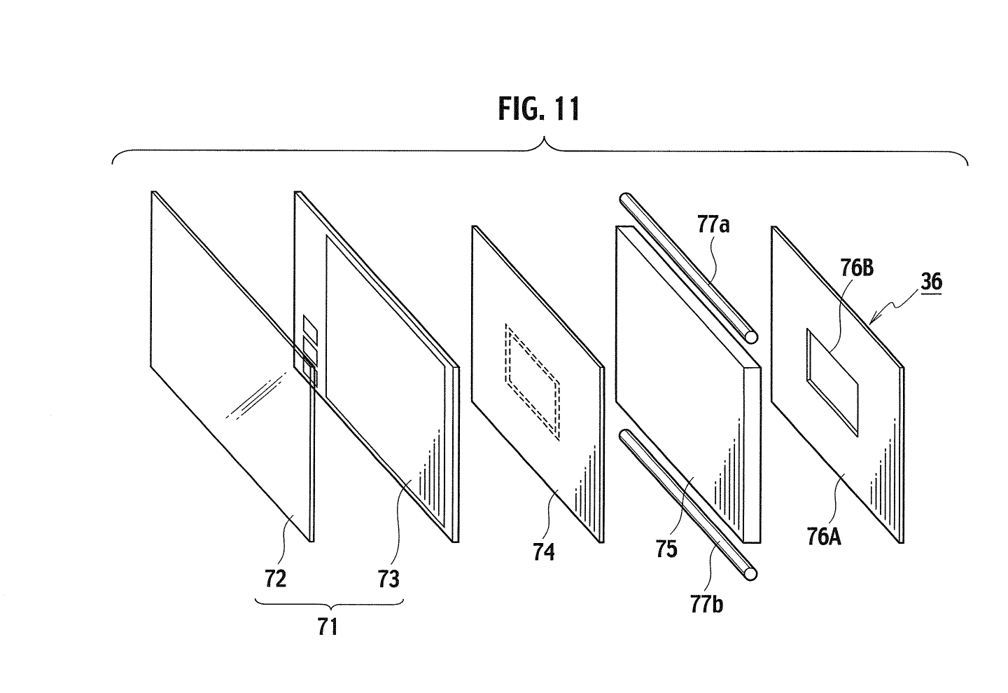

As shown in FIGS.10 and 11, the display 16 includes a front panel 71, a transparent liquid crystal panel 74, a light guiding panel 75, a reflection film 76, fluorescence lamps 77a, 77b, 78a, 78b, and lamp holders 79a to 79h.

The fluorescence lamps 77a, 77b are mounted on an upper side and a lower side of the light guiding panel 75. The lamp holders 79a, 79b are mounted on the upper side of the light guiding panel 75 to hold the fluorescence lamp 77a. The lamp holders 79c, 79d are mounted on the lower side of the light guiding panel 75 to hold the fluorescence lamp 77b. The fluorescence lamps 78a, 78b are mounted on an upper portion and a lower portion of a back side of the reflection film 76. That is, the fluorescence lamps 78a, 78b are positioned above and below the rotation reels 3A, 3B, 3C. The lamp holders 79e, 79f are mounted on the upper portion of the back side of the reflection film 76 to hold the fluorescence lamp 78a. The lamp holders 79g, 79h are mounted on the lower portion of the back side of the reflection film 76 to hold the fluorescence lamp 78b.

The front panel 71 includes a touch panel 72 and a display plate 73. The touch panel 72 is made of a transparent member and receives a player's operation. The display plate 73 is made of a transparent member. Various pictures and characters are drawn on the display plate 73. The various pictures and characters are drawn on an area other than the slot game areas A1 to A11, as viewed from a front side of the display 16. This allows a player to have visual contact with the various pictures and characters. The display 16 may omit the front panel 71.

The transparent liquid crystal panel 74 includes a first transparent substrate (e.g. a glass plate) in which a thin film transistor layer is formed, a second transparent substrate opposed to the first transparent substrate and a liquid crystal inserted in a space between the first transparent substrate and the second transparent substrate. The transparent liquid crystal panel 74 is set to a white display state under a condition where the liquid crystal is not driven. In the white display state, a player has visual contact with light which transmits through the transparent liquid crystal panel 74, as viewed from the front side of the display 16. The transparent liquid crystal panel 74 has a center region in which the liquid crystal is not driven anytime so that a player has visual contact with symbols drawn on the rotation reels 3A, 3B, 3C.

The light guiding panel 75 guides light emitted from the fluorescence lamps 77a, 77b toward the transparent liquid crystal panel 74, in order to light the transparent liquid crystal panel 74. The light guiding panel 75 is a transparent member such as an acrylate resin having the thickness of about two centimeters and a light guiding function.

The reflection film 76 is formed by evaporating silver on a white polyester film or an aluminum thin film. The reflection film 76 reflects light guided into the light guiding panel 75 toward a front side of the light guiding panel 75. The reflection film 76 has a reflection region 76A and a non-reflection region 76B. A transparent material is arranged on the non-reflection region 76B and a player has visual contact with symbols drawn on the rotation reels 3A, 3B, 3C through the non-reflection region 76B.

The fluorescence lamp 77a is held by the lamp holders 79a, 79b at both ends thereof. The fluorescence lamp 77b is held by the lamp holders 79c, 79d at both ends thereof. A part of light emitted from the fluorescence lamps 77a, 77b is reflected by the reflection film 76 on the reflection region 76A to light the transparent liquid crystal panel 74.

The fluorescence lamp 78a is held by the lamp holders 79e, 79f at both ends thereof. The fluorescence lamp 78b is held by the lamp holders 79g, 79h at both ends thereof. A part of light emitted from the fluorescence lamps 78a, 78b is reflected by the rotation reels 3A, 3B, 3C on the outer surfaces of the rotation reels 3A, 3B, 3C. Apart of reflected light enters into the non-reflection region 76B to light the transparent liquid crystal panel 74.

Thereby, the display 16 can display symbols drawn on the rotation reels 3A, 3B, 3C on the specified slot game area A1 and digital images on the slot game areas A2 to A11.

The rotation reels 3A, 3B, 3C are mechanical reels. The rotation reels 3A, 3B, 3C are laid at certain intervals one another. Each rotation reel is formed in a drum type and connected to each stepping motor. When the stepping motors 45A, 45B, 45C are driven, the rotation reels 3A, 3B, 3C are rotated. This allows a player to have visual contact with scrolling symbols.

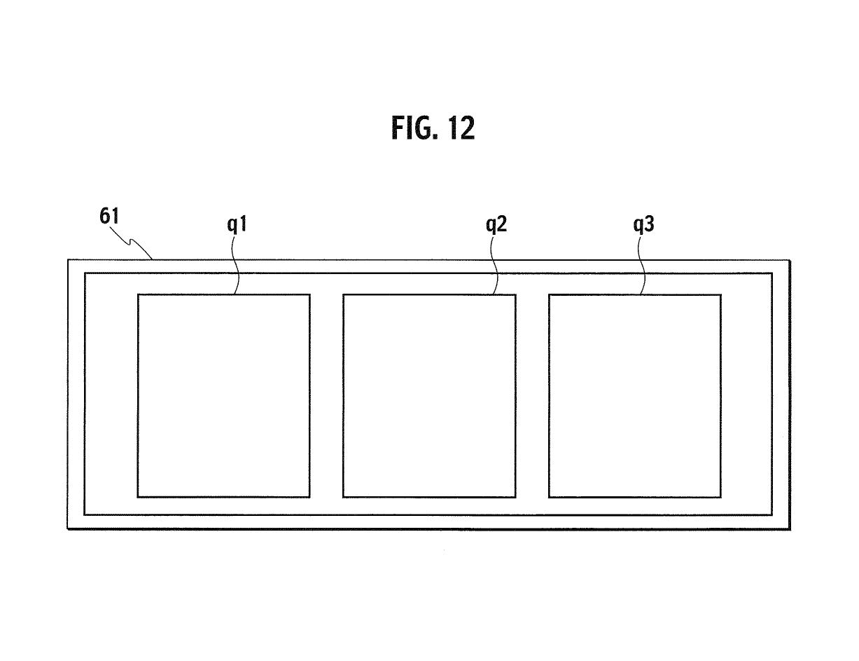

Next, with reference to FIG.12, one display example of the specified slot game area A1 will be described below.

As shown in FIG.12, the display region set on the specified slot game area A1 has three sections q1, q2, q3. When the slot machine 10 executes a slot game on the specified slot game area A1, symbols are variably displayed on the sections q1, q2, q3.

An activation area notifying frame 61 surrounds the sections q1, q2, q3 on the specified slot game area A1. When the specified slot game area A1 is activated, that is, one or more credits corresponding to one or more medals are bet on the specified slot game area A1, the activation area notifying frame 61 lights up. Thereby, a player can recognize that the specified slot game area A1 is activated.

One payline is set on the specified slot game area A1. When one or more credits corresponding to one or more medals are bet on the specified slot game area A1, the payline is activated. If symbols constituting a winning combination are stopped on the activated payline, the slot machine 10 provides a payout.

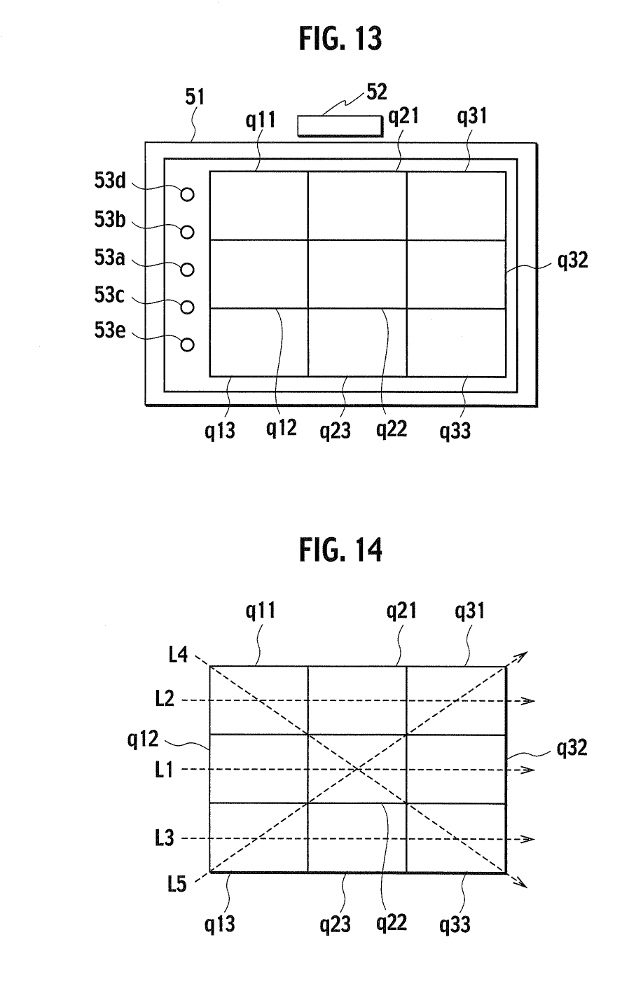

Next, with reference to FIG.13, one display example of each of the slot game areas A2 to A11 will be described below.

As shown in FIG.13, the display region set on each of the slot game areas A2 to A11 has nine sections q11 to q33. When the slot machine 10 executes a slot game on each slot game area, symbols are variably displayed on the sections q11 to q33.

Five light emitting diodes (LEDs) 53a to 53e are set on a left side of each display region. Each of the LEDs 53a to 53e lights up according to the number of bet credits. More specifically, the LED 53a lights up when one or more credits corresponding to one medal are bet on each slot game area. The LEDs 53a to 53c light up when one or more credits corresponding to two medals are bet on each slot game area. The LEDs 53a to 53e light up when one or more credits corresponding to three medals are bet on each slot game area.

Thus, the LEDs 53a to 53e notify activated paylines L1 to L5 set on each slot game area. As shown in FIG.14, the payline L1 crosses the sections q12, q22, q32. The payline L2 crosses the sections q11, q21, q31. The payline L3 crosses the sections q13, q23, q33. The payline L4 crosses the sections q11, q22, q33. The payline L5 crosses the sections q13, q22, q31.

When the payline L1 is activated, the LED 53a lights up. When the paylines L2, L3 are activated, the LEDs 53b, 53c light up. When the paylines L4, L5 are activated, the LEDs 53d, 53e light up. Therefore, when one or more credits corresponding to one medal are bet on each slot game area, the payline L1 is activated. When one or more credits corresponding to two medals are bet on each slot game area, the paylines L1 to L3 are activated. When one or more credits corresponding to three medals are bet on each slot game area, the paylines L1 to L5 are activated. If symbols constituting a winning combination are stopped on each activated payline, the slot machine 10 provides a payout.

An activation area notifying frame 51 surrounds the sections q11 to q33 on each slot game area. When each slot game area is activated, that is, one or more credits corresponding to one or more medals are bet on each slot game area, the activation area notifying frame 51 lights up. Thereby, a player can recognize which slot game area is activated from among the slot game area A2 to A11.

A bonus notifying portion 52 is set on an upper side of each slot game area. When the slot machine 10 executes a bonus game on each slot game area, the bonus notifying portion 52 lights up. Thereby, a player can recognize which slot game area provides the bonus game.

Next, with reference to FIG.15, a relation between a winning combination and an amount of payout on each slot gaming area in the slot machine 10 will be described below.

As shown in FIG.15, in a condition where we assume that the payline L1 is only activated on each of the slot game areas A2 to A11 (that is, one or more credits corresponding to one medal are bet on the slot game area), when three “7” symbols are statically displayed on the payline L1, the slot machine 10 executes a bonus game on the slot game area. When three “APPLE” symbols are statically displayed on the payline L1, the slot machine 10 provides one or more credits corresponding to fifteen medals. When three “BELL” symbols are statically displayed on the payline L1, the slot machine 10 provides one or more credits corresponding to ten medals. When one “CHERRY” symbol is statically displayed on the left end of the payline L1, the slot machine 10 provides one or more credits corresponding to two medals.

On the other hand, under a condition that we assume that one or more credits corresponding to one medal are bet on the specified slot game area A1, when three “7” symbols are statically displayed on the specified slot game area A1, the slot machine 10 adds one or more credits corresponding to fifteen medals to one or more credits provided on one or more bet slot game areas other than the specified slot game area A1 to generate the total amount of payout. Then, the slot machine 10 multiplies the total amount of payout by five and then provides the multiplied total amount of payout. When three “APPLE” symbols are statically displayed on the specified slot game area A1, the slot machine 10 adds one or more credits corresponding to fifteen medals to one or more credits provided on one or more bet slot game areas other than the specified slot game area A1 to generate the total amount of payout. Then, the slot machine 10 multiplies the total amount of payout by three and then provides the multiplied total amount of payout. When three “BELL” symbols are statically displayed on the specified slot game area A1, the slot machine 10 adds one or more credits corresponding to ten medals to one or more credits provided on one or more bet slot game areas other than the specified slot game area A1 to generate the total amount of payout. Then, the slot machine 10 multiplies the total amount of payout by two and then provides the multiplied total amount of payout.

For example, we assume that the slot game areas A1 to A11 are activated, three “APPLE” symbols are statically displayed on the specified slot game area A1, three “APPLE” symbols are statically displayed on an activated payline of the slot game area A4, and three “BELL” symbols are statically displayed on an activated payline of the slot game area A8. In this case, the total amount of payout is one or more credits corresponding to forty medals (40=15+15+10). Then, the slot machine 10 multiplies the total amount of payout by three and then provides one or more credits corresponding to one hundred and twenty medals (120=40*3).

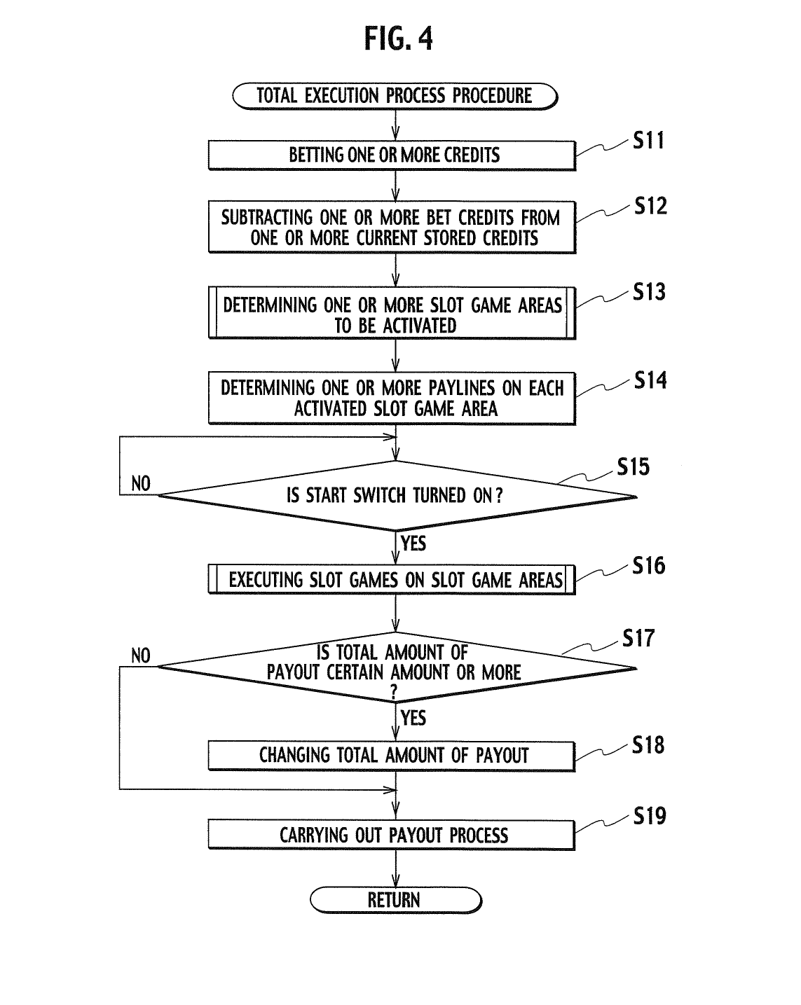

Next, with reference to FIGS.4 to 9, process procedures of the slot machine 10 will be described below. FIG.4 is a flow chart illustrating a total execution process procedure of the slot machine 10.

In step S11, a player presses the BET switch 25 to bet one or more credits on one or more slot game areas, or inserts one or more medals into the medal insertion slot 21 to bet one or more credits corresponding to the inserted one or more medals. In step S12, the CPU 106 subtracts one or more bet credits from one or more current stored credits when the BET switch 25 is pressed. For example, when fifty credits are stored and thirty credits are bet, the CPU 106 subtracts thirty from fifty to obtain twenty credits.

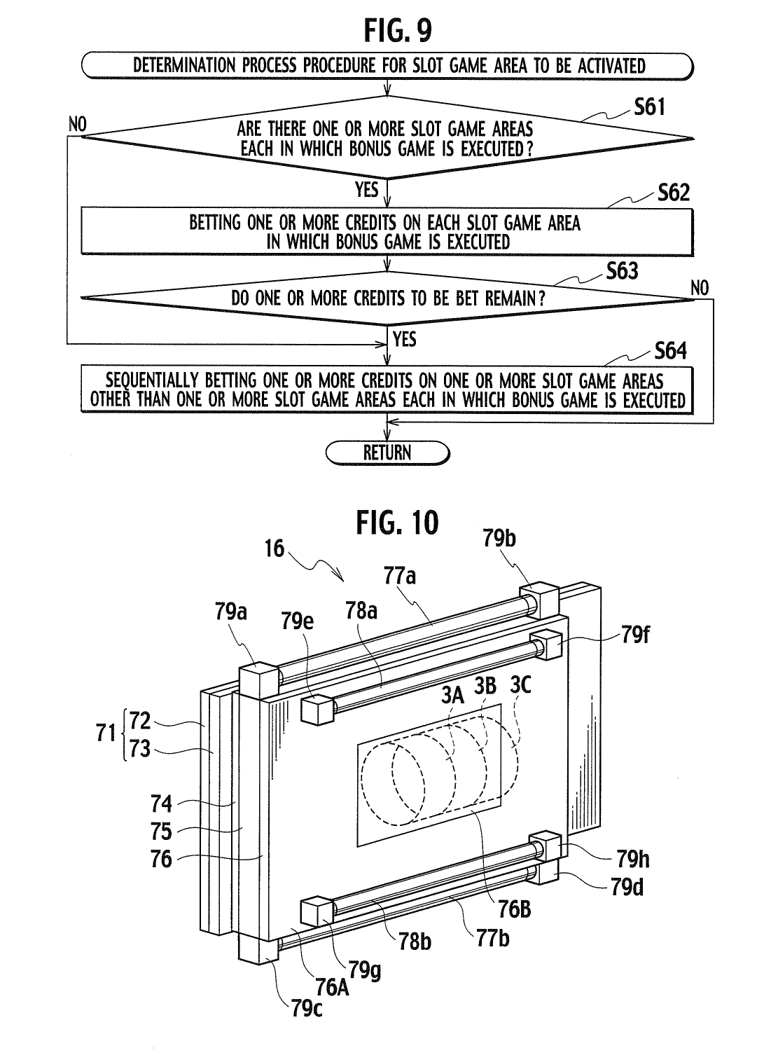

In step S13, the CPU 106 determines one or more slot game areas to be activated, from among the slot game areas A1 to A11. This process will be described later, with reference to FIG.9.

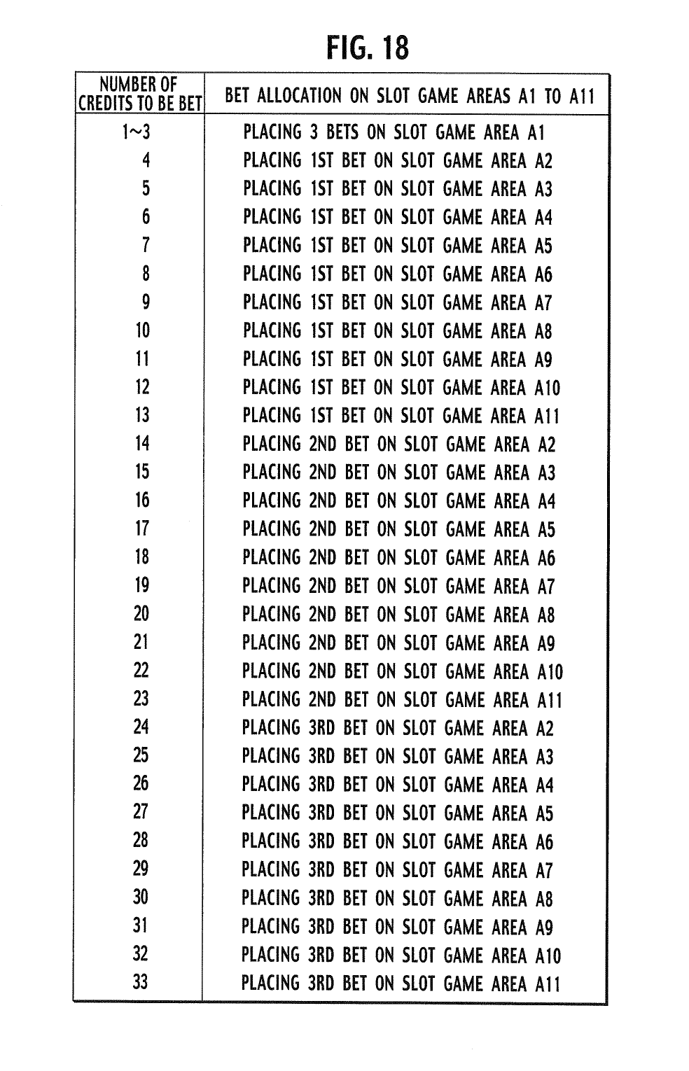

In step S14, the CPU 106 determines one or more paylines to be activated on each of one or more activated slot game areas. In this process, when one or more credits corresponding to one medal are bet, the CPU 106 bets one credit on the specified slot game area A1 and activates the payline on the specified slot game area A1. When one or more credits corresponding to two medals are bet, the CPU 106 bets two credits on the specified slot game area A1 and activates the payline on the specified slot game area A1. When one or more credits corresponding to three medals are bet, the CPU 106 bets three credits on the specified slot game area A1 and activates the payline on the specified slot game area A1. When one or more credits corresponding to four or more medals are bet, the CPU 106 bets three credits on the specified slot game area A1, activates the payline on the specified slot game area A1, bets one or more remaining credits on one or more slot game areas other than the specified slot game area A1, and activates one or more paylines on each bet slot game area other than the specified slot game area A1 (see FIG.18). In this case, when one credit is bet on each slot game area, the CPU 106 activates the payline L1. When two credits are bet on each slot game area, the CPU 106 activates the paylines L1 to L3. When three credits are bet on each slot game area, the CPU 106 activates the paylines L1 to L5. When one or more credits are bet on each slot game area, the CPU 106 lights the activation area notifying frame 51 or 61 to notify the player of one or more activated slot game area.

For example, in a case where we assume that the slot game areas A1 to A6 are activated, the CPU 106 lights the activation area notifying frames 51, 61 on the slot game areas A1 to A6 and does not light the activation area notifying frames 51 on the slot game areas A7 to A11.

In step S15, the CPU 106 determines whether or not the start switch 27 is turned on. If the start switch 27 is turned on, the process proceeds to the step S16. If the start switch 27 is not turned on, the process remains in the step S15. In step S16, the CPU 106 executes slot games on the slot game area A1 to A11.

In step S17, the CPU 106 determines whether or not the total amount of payout is a certain amount or more. If the total amount of payout is the certain amount or more, the process proceeds to step S18. If the total amount of payout is not the certain amount or more, the process proceeds to step S19. In step S18, the CPU 106 changes the total amount of payout according to the play result of the specified slot game area A1. For example, in a condition where we assume that three “BELL” symbols are statically displayed on the specified slot game area A1 and the total amount of payout is one hundred and thirty-two medals, the CPU 106 multiplies the total amount of payout by two and then provides one or more credits corresponding to two hundreds and sixty-four medals.

In step S19, the CPU 106 carries out a payout process and then the process is finished. When the payout process is carried out, the CPU 106 pays out one or more medals through the medal payout slot 28 or adds one or more credits to one or more current stored credits, according to the total amount of payout.

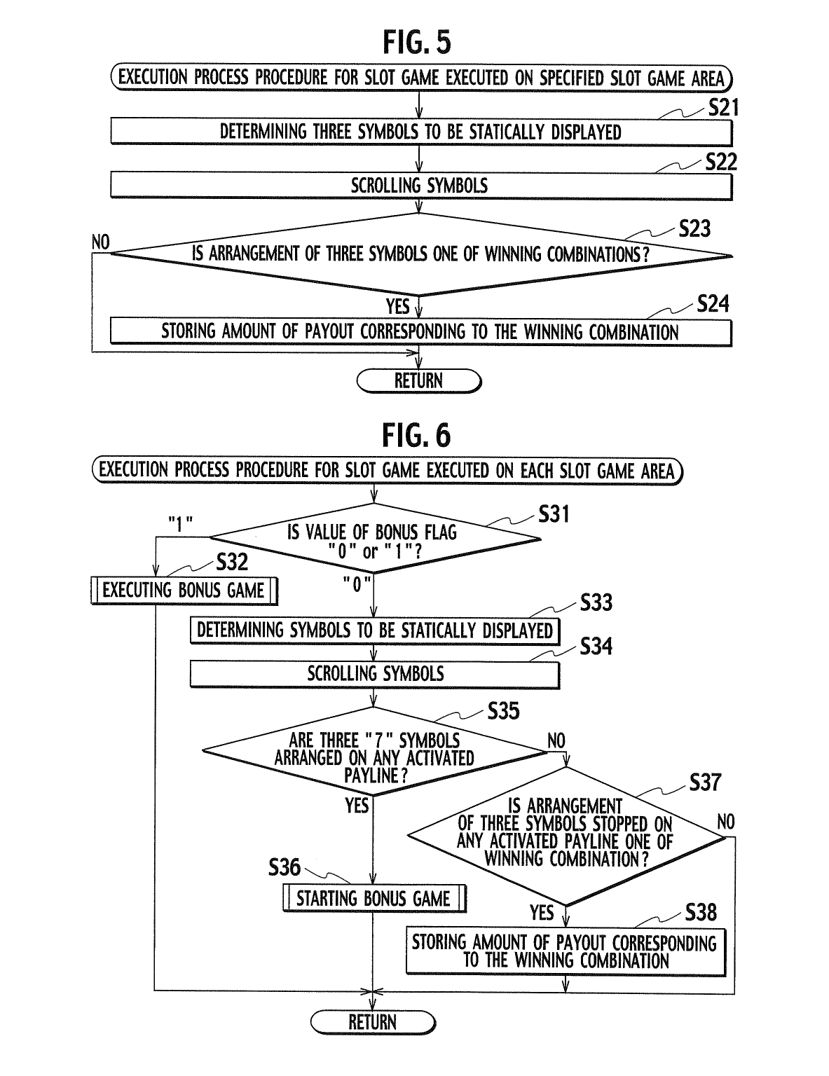

FIG.5 is a flow chart illustrating an execution process procedure (step S16) for a slot game which is executed on the specified slot game area A1.

In step S21, the CPU 106 determines three symbols to be statically displayed on the sections q1, q2, q3 of the specified slot game area A1.

In step S22, the CPU 106 dynamically displays (scrolls) symbols on the sections q1, q2, q3. After a predetermined time has elapsed, three symbols, which are determined in step S21, are statically displayed on the sections q1, q2, q3.

In step S23, the CPU 106 determines whether or not an arrangement of three symbols is one of winning combinations. If the arrangement of three symbols is one of winning combinations, the process proceeds to step S24. If the arrangement of three symbols is not any winning combinations, the process is finished or returned to step S21. In step S24, the CPU 106 stores an amount of payout corresponding to the winning combination in the RAM 110 and then the process is finished or returned to step S21. The amount of payout stored in the step S24 is used in the processes of steps S17, S18.

FIG. 6 is a flow chart illustrating an execution process procedure (step S16) for a slot game which is executed on each of the slot game areas A2 to A11.

In step S31, the CPU 106 determines whether a value of bonus flag is “0” or “1” on the slot game area. The value of bonus flag is changed into “1” when a bonus game is executed on the slot game area. The value of bonus flag is initially set to “0”. If the value of bonus flag is “1”, the process proceeds to step S32. If the value of bonus flag is “0”, the process proceeds to step S33.

In step S32, the CPU 106 executes a bonus game on the slot game area and then the process is finished or returned to step S31.

In step S33, the CPU 106 determines symbols to be statically displayed on the sections q11 to q33 of the slot game area. In step S34, the CPU 106 dynamically displays (scrolls) symbols on the sections q11 to q33. After a predetermined time has elapsed, symbols, which are determined in step S33, are statically displayed on the sections q11 to q33.

In step S35, the CPU 106 determines whether or not three “7” symbols are arranged on any activated payline of the slot game area. For example, when five paylines L1 to L5 shown in FIG.14 are activated, the CPU 106 determines whether or not three “7” symbols are arranged on any activated payline. If three “7” symbols are arranged on any activated payline, the process proceeds to step S36. If three “7” symbols are not arranged on any activated payline, the process proceeds to step S37.

In step S36, the CPU 106 starts a bonus game on the slot game area and then the process is finished or returned to step S31. In step S37, the CPU 106 determines whether or not an arrangement of three symbols, which are stopped on any activated payline of the slot game, is one of winning combinations. If the arrangement of three symbols is one of winning combinations, the process proceeds to step S38. If the arrangement of three symbols is not any winning combinations, the process is finished and returned to step S31.

In step S38, the CPU 106 stores an amount of payout corresponding to the winning combination in the RAM 110 and then the process is finished or returned to step S31. The amount of payout stored in the step S38 is used in the processes of steps S17, S18 shown in FIG.4.

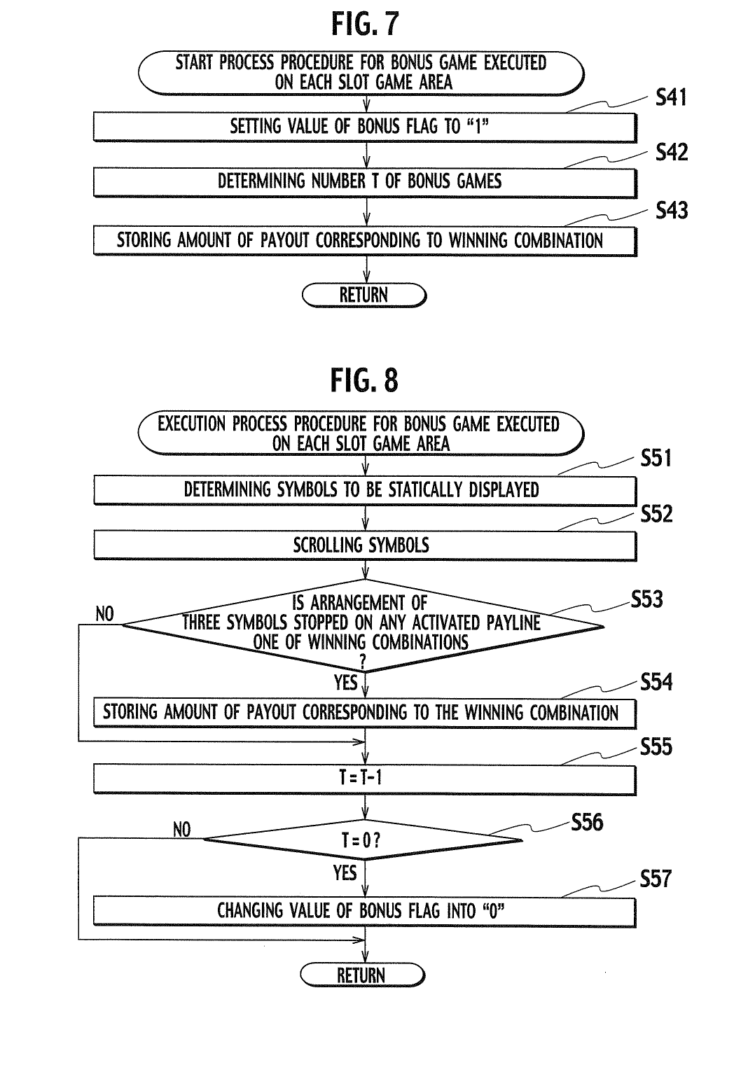

FIG.7 is a flow chart illustrating a start process procedure (step S36) for a bonus game which is executed on each of the slot game areas A2 to A11.

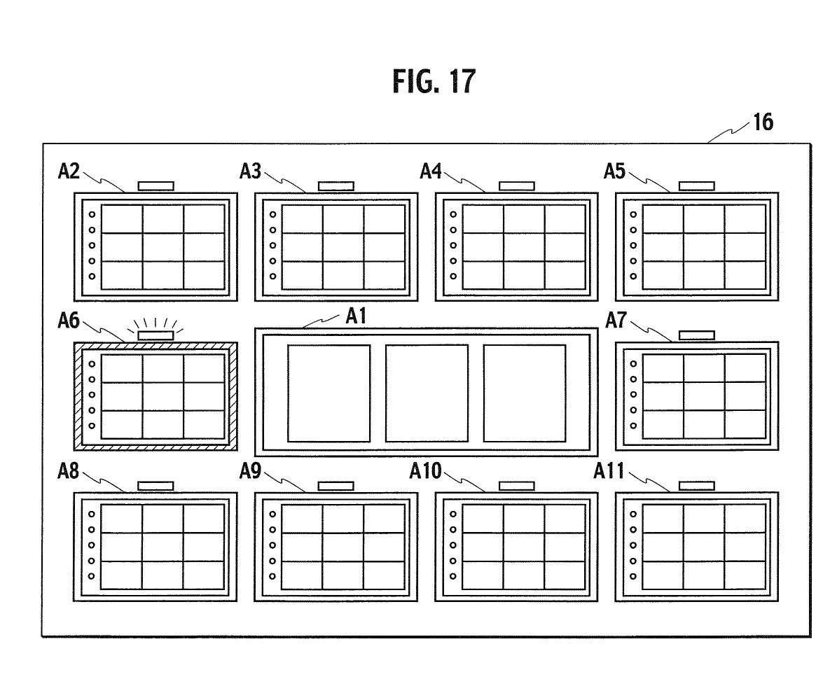

In step S41, the CPU 106 set a value of the bonus flag to “1”, when determining that three “7” symbols are arranged on any activated payline of each of the slot game areas A2 to A11 in step S35 shown in FIG.6. In this time, the CPU 106 causes the bonus notifying portion 52 shown in FIG. 13 to light up to notify a player of the execution of bonus game. For example, as shown in FIG.17, when a bonus game is executed on the slot game area A6, the CPU 106 causes the bonus notifying portion 52 to light up. Additionally, the CPU 106 may cause the activation area notifying frame 51 to light up in order to effectively notify the player of the execution of bonus game.

In step S42, the CPU 106 determines the number T of bonus games. For example, the number T of bonus game is a constant value (e.g. 50). Alternatively, the number T of bonus game may be randomly changed every bonus games. The number T of bonus game is stored in the RAM 110.

In step S43, the CPU 106 stores an amount of payout corresponding to the winning combination, which is an arrangement of three “7” symbols, in the RAM 110 and then the process is finished. The amount of payout stored in the step S38 is used in the processes of steps S17, S18 shown in FIG.4.

FIG. 8 is a flow chart illustrating an execution process procedure (step S32) for a bonus game which is executed on each of the slot game areas A2 to A11.

In step S51, the CPU 106 determines symbols to be statically displayed on the sections q11 to q33 of each of the slot game areas A2 to A11. It is noted that three “7” symbols are not arranged on any activated payline of the slot game area in this step, and one or more winning combinations are established on any activated payline of the slot game area in high ratio. Namely, in a bonus game, three “BELL” symbols, three “APPLE” symbols, or one “CHERRY” symbol shown in FIG.15 is arranged on any activated payline in high ratio, in comparison with a slot game other than a bonus game.

In step S52, the CPU 106 dynamically displays (scrolls) symbols on the sections q11 to q33. After a predetermined time has elapsed, symbols, which are determined in step S51, are statically displayed on the sections q11 to q33.

In step S53, the CPU 106 determines whether or not an arrangement of three symbols, which are stopped on any activated payline of the slot game area, is one of winning combinations. If the arrangement of three symbols is one of winning combinations, the process proceeds to step S54. If the arrangement of three symbols is not any winning combinations, the process proceeds to step S55.

In step S54, the CPU 106 stores an amount of payout corresponding to the winning combination in the RAM 110. The amount of payout stored in the step S54 is used in the processes of steps S17, S18 shown in FIG.4.

In step S55, the CPU 106 subtracts “1” from the number T of bonus games. In step S56, the CPU 106 determines whether or not the number T of bonus games is “0”. If the number T of bonus games is “0”, the process proceeds to step S57. If the number T of bonus games is not “0”, the process is finished. In step S57, the CPU 106 changes the value of bonus flag into “0” and then the process is finished.

FIG.9 is a flow chart illustrating a determination process procedure (step S13) for a slot game area to be activated. It is noted that this process procedure can interrupt the execution of slot games on the slot game areas A1 to A11 (step S16).

In step S61, when one or more medals are inserted from the medal insertion slot 21 or the BET switch 25 is pressed, the CPU 106 determines whether or not there are one or more slot game areas each in which a bonus game is executed. If there are the one or more slot game areas, the process proceeds to step S62. If there are not the one or more slot game areas, the process proceeds to step S63.

In step S62, the CPU 106 bets one or more credits on one or more slot game areas each in which a bonus game is executed. In step S63, the CPU 106 determines whether or not one or more credits to be bet remain. If one or more credits to be bet remain, the process proceeds to step S64. If one or more credits to be bet do not remain, the process is finished.

In step S64, the CPU 106 sequentially bets one or more credits on one or more slot game areas other than one or more slot game areas each in which the bonus game is executed and then the process is finished.

More specifically, as shown in FIG.18, first to third credits are bet on the slot game area A1, a fourth credit is bet on the slot game area A2 and a fifth credit is bet on the slot game area A3. After a thirteenth credit is bet on the slot game area A11, a fourteenth credit is bet on the slot game area A2. Thus, one or more credits are sequentially bet on one or more slot game areas. When thirty-third credit is bet, three credits are bet on each of the slot game area Al to A11.

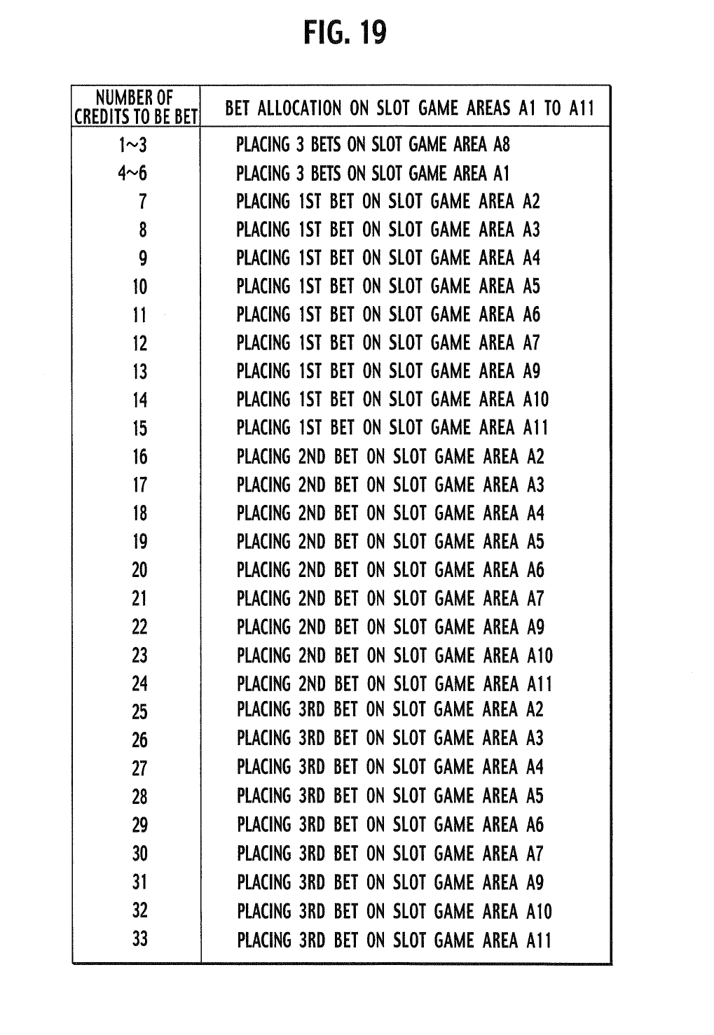

For example, we assume that a bonus game is executed on the slot game area A8. As shown in FIG.19, first to third credits are bet on the slot game area A8, fourth to sixth credits are bet on the slot game area A1, a seventh credit is bet on the slot game area A2 and an eighth credit is bet on the slot game area A3. After a fifteenth credit is bet on the slot game area A11, a sixteenth credit is bet on the slot game area A2. Thus, one or more credits are sequentially bet on one or more slot game areas. When thirty-third credit is bet, three credits are bet on each of the slot game area A1 to A11.

In the above-described example, although we assume that a bonus game is only executed on the slot game area A8, if two or more bonus games are executed on two or more slot game areas, the CPU 106 preferentially bets four or more credits on two or more slot game areas each in which a bonus game is executed. Then, the CPU 106 bets one or more remaining credits on one or more other slot game areas.

Next, the advantageous features of the slot machine 10 will be described below.

The slot machine 10 and the playing method of the slot machine 10 allow a player to execute plural-times slot games with respect to one-time insertion of one or more medals or one-time bet of one or more credits because the slot machine 10 can execute plural slot games on the slot game areas Al to A11.

The slot machine 10 and the playing method of the slot machine 10 increase player's expectations and entertainment factors because the total amount of payout is changed according to the play result of the specified slot game area A1.

The slot machine 10 and the playing method of the slot machine 10 increase player's expectations and entertainment factors because the multiplying factor of the total amount of payout is changed according to the play result of the specified slot game area A1.

The slot machine 10 and the playing method of the slot machine 10 change the total amount of payout according to the play result of the specified slot game area A1 when the total amount of payout is a certain amount or more. Thus, the slot machine 10 and the playing method of the slot machine 10 further increase entertainment factors because the change of the total amount of payout is omitted at the time when the total amount of payout is below the certain amount.

It is noted that the slot machine 10 and the playing method of the slot machine 10 may change the total amount of payout according to the play result of the specified slot game area A1 when a total amount of payout for a part of the slot game areas A1 to A11 is a certain amount or more.

Although the slot machine and the playing method of the slot machine of the present invention are described according to the exemplary embodiment with reference to FIGS.1 to 19, those are not limited to the exemplary embodiment. Each element of the slot machine 10 may be replaced by an element having a similar function.

For example, although the slot machine 10 executes slot games on the slot game areas A1 to A11 every one-time bet of one or more credits regardless whether or not each slot game area is activated, the slot machine 10 may executes one or more slot games on only one or more activated slot game areas.

Further, although the rotation reels (mechanical reels) 3A, 3B, 3C are mounted on the specified slot game areas A1, video reels instead of the rotation reels 3A, 3B, 3C may be mounted on the specified slot game areas A1.

Furthermore, although the video reels are mounted on the slot game areas A2 to A11, rotation reels (mechanical reels) instead of the video reels may be mounted on the slot game areas A2 to A11.

What is claimed is:

1. A slot machine comprising:
a display that is provided with slot game areas each in which a slot game is executed to rearrange symbols arranged thereon;
an input device that reads the number of credits bet by a player; and
a controller that activates one or more slot game areas according to the number of credits read by the input device, executes one or more slot games on one or more activated slot game areas, and changes an amount of payout, which is determined based on symbols rearranged on one or more activated slot game areas, according to a result of slot game executed on a specified slot game area.

2. The slot machine according to claim 1, wherein the controller multiplies the amount of payout by a certain number according to the result of slot game executed on the specified slot game area.

3. The slot machine according to claim 2, wherein the controller multiplies the amount of payout by the certain number when the amount of payout is a certain amount or more.

4. A playing method of a slot machine comprising:
reading the number of credits bet by a player;
activating one or more slot game areas according to the number of read credits;
executing one or more slot games on one or more activated slot game areas;
determining an amount of payout that is determined based on symbols rearranged on one or more activated slot game areas; and
changing the amount of payout according to a result of slot game executed on a specified slot game area.

5. The playing method according to claim 4, wherein the playing method multiplies the amount of payout by a certain number according to the result of slot game executed on the specified slot game area.

6. The playing method according to claim 5, wherein the playing method multiplies the amount of payout by the certain number when the amount of payout is a certain amount or more.
